(19) United States
(12) Patent Application Publication
(10) Pub. No.: US 2012/0255912 A1
(43) Pub. Date: Oct. 11, 2012

(54) Process for Treating Water to be Treated by Clarification Comprising an Adsorption of a Portion of Clarified Water and a Clarification of a Mixture of Adsorbed Clarified Water and Water to be Treated

(75) Inventors: Isabelle Giraud, Nouvoitou (FR); Abdelkader Gaid, Paris (FR); Philippe Sauvignet, Saint-Etienne-En-Cogles (FR)

(73) Assignee: VEOLIA WATER SOLUTIONS & TECHNOLOGIES SUPPORT, Saint-Maurice Cedex (FR)

(21) Appl. No.: 13/444,006

(22) Filed: Apr. 11, 2012

(30) Foreign Application Priority Data
Apr. 11, 2011 (FR) 1153153

(51) Int. Cl. C02F 9/02; C02F 1/52; C02F 1/28

(52) U.S. Cl. 210/665; 210/669; 210/192

(57) ABSTRACT

Process for treating water to be treated by clarification comprising an adsorption of a portion of clarified water and a clarification of a mixture of adsorbed clarified water and water to be treated The invention pertains to a process for treating water to be treated comprising:
a step for clarifying said water to be treated producing a clarified water;
a step for placing a part of said clarified water in contact with a powdered adsorbent reagent producing a mixture of clarified water and powdered adsorbent reagent;
a step for mixing said mixture with said water to be treated;
a step for discharging the remainder of the clarified water.

### 1. FIELD OF THE INVENTION

The field of the invention is that of the treatment of industrial water (wastewater and process water), municipal water and drinkable water.

The invention can find application particularly in treatment for potabilizing (i.e. making drinkable) raw water with a dissolved organic carbon (DOC) concentration below 10 mg/l and preferably below 6 to 8 mg/l in small-sized installations or plants, the output rate of which is lower than or equal to 2,000 m³/h.

### 2. PRIOR ART AND ITS DRAWBACKS

In France, the public health code (decree dated 11 Jan. 2007) stipulates that the TOC (total organic carbon) concentration of drinkable water should be less than or equal to 2 mg/l.

To this end, various techniques have been developed to reduce the organic matter content of water to be made drinkable.

Thus, there is a known technique in which raw water is treated by putting it into contact with powdered activated carbon (PAC), and then by coagulation, flocculation and decantation, and possibly ballasted or weighted, with a view to producing treated water. An installation of this type is illustrated in FIG. 3.

The implementation of such a technique cannot be used to produce water with a TOC concentration lower than or equal to 2 mg/l, unless an economically unreasonable quantity of PAC is used. PAC is indeed an expensive adsorbent reagent in that it is relatively costly, its cost ranging approximately from [symbol] 1,500 to [symbol] 2,500 per ton.

Furthermore, it is known that organic matter comprises adsorbable organic matter (also known as dissolved organic matter), flocculable organic matter and hard organic matter (also called a “heel”). The application of such a technique therefore leads to treating a part of the flocculable organic matter by adsorption. PAC is in this case used inappropriately to treat not only non-flocculable adsorbable organic matter but also at least a part of the flocculable and adsorbable organic matter.

Another technique consists in treating raw water by coagulation, flocculation, and decantation, and possibly ballasted, in order to produce clarified water which undergoes percolation in a granular activated carbon (GAC) filter column in order to produce drinkable water.

The implementation of such a technique enables the production of drinkable water, the TOC concentration of which is far below that stipulated by the regulations, namely 2 mg/l. In other words, it leads to achieving excess quality, i.e. producing water, the quality of which is far higher than the desired quality. Such a technique is therefore not appropriate for treatment to potabilize (i.e. make drinkable) raw water with a dissolved organic carbon (DOC) concentration below 10 mg/l.

Besides, the capacities of adsorption of GAC of the column are finite. It is therefore necessary to regularly replenish this GAC. This tends to increase the cost of exploitation of this technique.

It is necessary to carry out regular operations for backwashing the column by injecting treated water therein so as to limit clogging. The consumption of treated water induced by these backwashing operations reduces the quantity of water produced and therefore the efficiency of this technique.

Finally, another technique consists in treating raw water by coagulation, flocculation and decantation, and possibly ballasted decantation, in order to produce clarified water. This clarified water is then introduced into a mixing zone into which PAC is injected. The treated water is then separated from the PAC by microfiltration or ultrafiltration.

The implementation of such a technique also leads to achieving excess quality because it enables the production of drinkable water with a TOC concentration far below that stipulated by the regulations, namely 2 mg/l. This technique too is therefore not appropriate for treatment to potabilize raw water with an organic matter concentration or dissolved organic carbon (DOC) concentration below 10 mg/l.

Besides, the separation of PAC from water entails the risk of causing a premature deterioration of the filtering membranes, and this is likely to entail excess investment costs.

### 3. GOALS OF THE INVENTION

The invention is aimed especially at overcoming these drawbacks of the prior art.

More specifically, it is a goal of the invention, in at least one embodiment, to provide a technique for treating water especially by clarification that enables the production of treated water in accordance with a sustainable development approach.

In particular, it is a goal of the invention to provide a technique of this kind used to treat raw water having a dissolved organic carbon (DOC) concentration below 10 mg/l with a view to producing, without excess quality, treated water whose TOC concentration is lower than or equal to 2 mg/l.

In particular, it is another goal of the invention, in at least one embodiment, to implement a technique of this kind that leads to reducing the consumption of adsorbent reagent.

It is yet another goal of the invention, in at least one embodiment, to procure a technique of this kind that can be implemented by the simple renovation of an existing water treatment plant, especially by clarification.

It is another goal of the invention, in at least one embodiment, to implement a technique of this kind that can be implemented with limited space requirement, especially in an installation with a small footprint.

The invention is also aimed at implementing a technique of this kind which, in at least one embodiment, is simple, reliable, efficient and economical.

### 4. SUMMARY OF THE INVENTION

These goals as well as others that shall appear here below are achieved by means of a process for treating water to be treated which, according to the invention, comprises:
a step for clarifying said water to be treated producing a clarified water;
a step for placing a part of said clarified water in contact with a powdered adsorbent reagent producing a mixture of clarified water and powdered adsorbent reagent;
a step for mixing said mixture with said water to be treated;
a step for discharging the remainder of the clarified water.

Thus, the invention relies on a wholly original approach in which a part of a clarified water coming from a clarification is re-circulated in a zone in which it is put into contact with a powdered adsorbent reagent and then the mixture of clarified water and adsorbent reagent thus obtained is introduced into the raw water to be treated upstream to the clarification.

An implementation of this kind enables the production of treated water with a TOC concentration lower than or equal to 2 mg/l, at a flow rate of less than 2,000 m³/h, from water to be treated that has a DOC concentration below 10 mg/l in using little adsorbent reagent and in a relatively compact installation.

As understood in the invention, the treated water is a raw water that has undergone a first clarification, an adsorption on a powdered adsorbent material, a mixing with raw water and a second clarification.

The implementation of a technique according to the invention therefore forms part of compliance with a sustainable development approach in as much as it enables the production of treated water having an appropriate quality that is not far higher than expectations in entailing low consumption of adsorbent reagent at a relatively reduced cost. The technique according to the invention therefore avoids the achieving of excess quality.

According to one advantageous characteristic of the invention, said step for clarifying comprises:
a step for coagulating said water to be treated producing coagulated water;
a step for flocculating said coagulated water producing flocculated water;
a step for decanting said flocculated water producing said clarified water and sludges.

The clarification is then obtained simply and efficiently by coagulation-flocculation-decantation, and possibly weighted or ballasted.

The fact of placing already coagulated and flocculated water into contact, according to the invention, enables the adsorption, on the powdered reagent, of only the adsorbable part of the organic matter and not also a part of the coagulable and flocculable organic matter. The powdered adsorbent reagent is therefore used efficiently. The quantity of powdered adsorbent reagent needed for treating the water can then be reduced.

The fact of mixing clarified water with powdered adsorbent reagent makes this water again coagulable and flocculable. Implementing the technique of the invention therefore enables the re-circulated water to be coagulated and flocculated twice before it is collected.

According to one advantageous characteristic, 25% to 75% and preferably 45% to 55% of said clarified water coming from said decantation step or said clarification step is put into contact with said powdered adsorbent reagent.

Advantageously, the flow rate of said clarified water coming from said step for discharging is from 40 to 2,000 m³/h and preferably from 100 to 500 m³/h.

A technique according to the invention is thus particularly intended for implementation in small-sized installations or plants.

Preferably, the dissolved organic carbon concentration of said water to be treated is below 10 mg/l.

One technique according to the invention is thus more particularly intended for the treatment of raw water to be made drinkable containing less than 10 mg/l and preferably less than 6 to 8 mg/l of DOC.

Advantageously, the powdered adsorbent reagent is powdered activated carbon.

An adsorbent reagent of this type is particularly efficient.

Any other type of powdered adsorbent reagent could be implemented such as for example resins, iron or manganese hydroxides or oxides, calcium carbonates and/or magnesium carbonates etc.

In one preferred embodiment, said process comprises a step for thickening said sludges, and a step for introducing the thickened sludges thus obtained into said mixture.

This implementation enables the use of the powdered reagent several times because the sludges coming from the decantation and thickening contain a powdered reagent.

The invention also pertains to a water treatment plant for treating water to be treated to implement a process as described here above, said plant comprising means for clarifying said water to be treated and means for extracting clarified water at exit from said means for clarifying.

According to the invention, such a plant comprises means for re-circulating a part of said clarified water into a stirred pre-contact zone, means for injecting a powdered adsorbent reagent into said pre-contact zone, and a mixing zone, said mixing zone comprising a first inlet connected to the outlet of said pre-contact zone, a second inlet for said water to be treated and an outlet leading into said means for clarifying.

In one advantageous embodiment, said means for clarifying comprise a coagulation zone, a flocculation zone, and a decantation zone mounted in series, and means for extracting said clarified water at exit from said decantation zone, the outlet of said mixing zone leading into said coagulation zone.

The invention also pertains to a process for renovating an existing plant for treating water to be treated comprising means for clarifying said water to be treated, such a process comprising:
a step consisting in linking said re-circulation means for re-circulating a part of the clarified water to the outlet of said clarifying means;
a step consisting in connecting said means for re-circulating to a pre-contact zone comprising means for injecting a powdered adsorbent reagent;
a step consisting in installing a mixing zone, of which a first inlet is connected to the outlet of said pre-contact zone, a second inlet is connected to an intake of said water to be treated and the outlet is connected to said means for clarifying.

The technique of the invention thus enables the very simple renovation of any existing plant or facility for treating water by clarification that does not enable the production of treated water with a TOC concentration lower than or equal to 2 mg/l in order to procure a plant for implementing a process of treatment according to the invention in order to produce treated water with a TOC concentration lower than or equal to 2 mg/l.

It is thus possible to re-use existing plants by converting them rather than destroy them and build new ones from scratch. In this sense, the invention forms part of a sustainable development approach.

According to one advantageous characteristic, said means for clarifying comprise a coagulation zone, a flocculation zone and a decantation zone mounted in series, and means for extracting clarified water at exit from said decantation zone, said process comprising:
a step consisting in connecting means for re-circulating a part of clarified water to the outlet of said decantation zone;
a step consisting in connecting said means for re-circulating to a pre-contact zone comprising means for injecting powdered adsorbent reagent;
a step for installing a mixing zone, a first inlet of which is connected to the outlet of said pre-contact zone, a second inlet of which is connected to an intake of said water to be treated and the outlet of which is connected to said coagulation zone.

The technique of the invention thus makes it possible to recycle an existing plant for treatment by coagulation-flocculation-decantation, and possibly ballasted, in order to procure an installation to implement a treatment process enabling the production, without excess quality, of drinkable water having a TOC concentration below 2 mg/l.

### 5. LIST OF FIGURES

Other characteristics and advantages of the invention shall appear more clearly from the following description of a preferred embodiment, given by way of a simple illustratory and non-exhaustive example and from the appended drawings, of which:

FIG. 1 illustrates an example of a water treatment plant according to the invention;

FIG. 2 illustrates an plant for treating water by ballasted coagulation-flocculation-decantation according to the prior art;

FIG. 3 illustrates a plant for the treatment of water by ballasted coagulation-flocculation-decantation according to the prior art that implements a pre-contact tank for raw water to be treated with PAC upstream to the coagulation;

FIG. 4 illustrates an installation implemented by the inventors in trials, in which the plants, illustrated respectively in FIGS. 2 and 3, are placed in series.

### 6. DESCRIPTION OF ONE EMBODIMENT OF THE INVENTION

6.1. Reminder of the General Principle of the Invention

The general principle of the invention is based on re-circulating a part of clarified water coming from an operation of clarification in a zone in which it is put into contact with a powdered adsorbent reagent and then introducing the mixture of clarified water and adsorbent reagent obtained, into the raw water to be treated, upstream from the clarification.

Such an implementation enables the production of treated water, the TOC concentration of which is lower than or equal to 2 mg/l, at a flow rate of less than 2,000 m³/h, from raw water with a DOC concentration below 10 mg/l in using little adsorbent reagent and in a relatively compact installation.

6.2. Example of an Installation According to the Invention

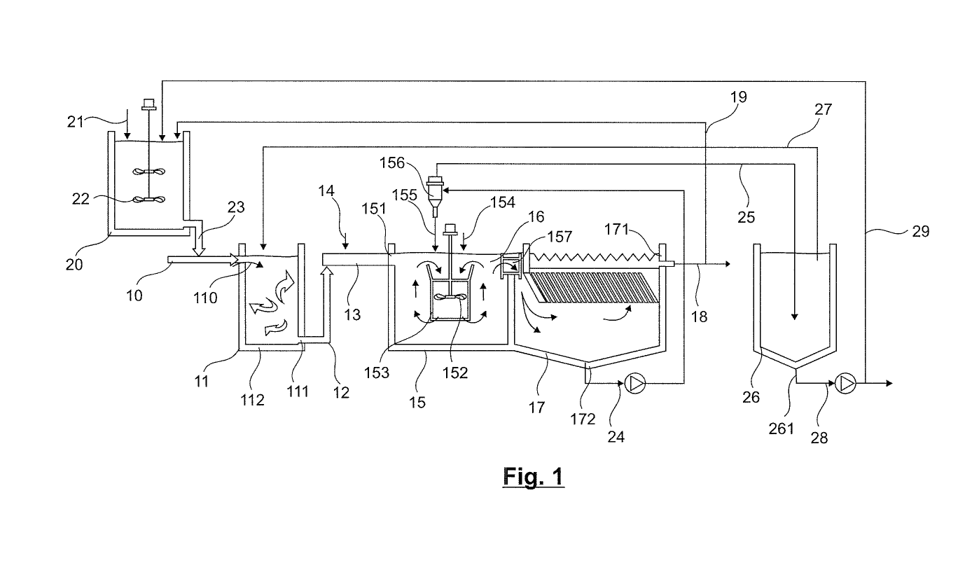

Referring to FIG. 1, we present an embodiment of a water treatment installation according to the invention.

Thus, as shown in FIG. 1, such an installation comprises an intake conduit 10 for raw water to be treated. The outlet of this conduit 10 leads into a mixing zone comprising a mixing tank 11.

The mixing tank 11 has an inlet 110 at the upper part and an outlet 111 in proximity to its bottom 112. The outlet 111 is connected to a piping 12.

The piping 12 leads into a coagulation zone that comprises a static mixer 13 and means 14, such as an injector, for injecting a coagulant reagent into the static mixer 13. The static mixer 13 leads into the inlet 151 of a flocculation tank 15 of a flocculation zone.

The flocculation tank 15 houses an agitator or stirrer 152 comprising blades or paddles capable of being driven rotationally around an essentially vertical axis.

The agitator 152 is housed within a flow guide 153, the lower part of which defines a hollow cylinder and the upper part of which defines a truncated cone.

The flocculation zone comprises means for injecting a flocculating reagent 154 into the flocculation tank 15. It also has means for injecting ballast into the flocculation tank 15. In this embodiment, the ballast is microsand 155 and the ballast injection means comprise a hydrocyclone 156.

The flocculation tank 15 has an outlet 157 that is provided with a deflector 16 to optimize the hydraulic circulation, and leads into a liquid/solid separation zone which comprises a lamellar decanter or separator 17.

The lamellar decanter 17 comprises, at the upper part, a clarified water outlet 171 and at the lower part, an outlet 172 for decantation sludges.

The clarified water outlet 171 is connected to a piping 18 for extracting treated water.

A piping 19 for re-circulating clarified water is connected in a bypass to the extraction pipe 18. It leads into the pre-contact tank 20 of a pre-contact zone.

The pre-contact zone comprises means for injecting a powdered adsorbent reagent 21. In this embodiment, it is powdered activated carbon (PAC). It also has a paddle stirrer 22 capable of being driven rotationally about an essentially vertical axis within the pre-contact tank 20.

The bottom of the pre-contact tank 20 comprises an outlet of a mixture of clarified water and PAC which is connected to a piping 23 which opens into the raw water intake piping 10.

The sludge outlet 172 is connected to a re-circulation piping 24 which leads into the inlet of the hydrocyclone 156.

The hydrocyclone 156 comprises an outlet of a mixture of sludges and a very small quantity of ballast that is connected to a piping 25. The sludges contain PAC. The piping 25 opens into a thickener tank 26.

A piping 27 for re-circulation of a supernatant connects the upper part of the thickener tank 26 to the mixing tank 11.

The thickener tank 26 has a outlet 261 for thickened sludges at its lower part.

The sludge outlet 261 is connected to a sludge extraction piping 28.

A piping 29 for re-circulating thickened sludges is mounted in a bypass on the sludge extraction piping 28 and leads into the pre-contact tank 20.

6.3. Example of a Process According to the Invention

A process according to the invention consists for example in conveying water to be treated through a intake conduit 10 into the mixing tank 11 at a flow rate of 40 to 2000 m³/h and preferably 100 to 500 m³/h.

The water to be treated preferably has a DOC concentration below 10 mg/l and preferably below 6 to 8 mg/l.

The water to be treated is then conveyed through the piping 12 into the static mixer 13 within which it is put into contact with at least one coagulant reagent introduced into the static mixer 13 by the injection means 14. The concentration of water in coagulant will preferably range from 10 to 250 ppm. It could for example be FeCl₃ or an aluminum-based coagulant.

The coagulated water is then introduced into the flocculation tank 15. At least one flocculating reagent is injected through the injection means 154 into the stirred flocculation tank 15. The flocculent concentration in water will preferably be from 0.1 to 1 ppm. Microsand 155 is also injected into the flocculation tank 15 through the hydrocyclone 156.

The flocculated water coming from the flocculation tank 15 is then introduced into the decanter 17 through the outlet 157 and the deflector 16. The clarified water is separated therein from the sludges.

The clarified water is extracted in an overflow from the decanter via the outlet 171 and the extraction piping 18.

Between 25% and 75% and preferably between 45 and 55% of the extracted clarified water flowing in the piping 18 is re-circulated via the piping 19 in the pre-contact tank 20.

The re-circulated clarified water is put into contact therein with a powdered adsorbent reagent which, in this embodiment, is PAC which is introduced into the stirred pre-contact tank 20 through the injection means 21. The PAC concentration of the mixture obtained preferably ranges from 0 to 200 ppm depending on the nature of the PAC implemented and the type of water to be treated. It will thus preferably range from 0 to 30 ppm for the treatment of drinkable water and preferably between 0 and 200 ppm for the treatment of industrial or other wastewater.

The mixture of clarified water and PAC coming from the pre-contact tank 20 is introduced into the mixing tank 11 through the piping 23. The water to be treated as well as the mixture of clarified water and PAC are mixed together therein.

The mixture of raw water, re-circulated clarified water and PAC thus obtained undergoes coagulation, flocculation and decantation.

As already explained, at the exit from the decanter 17, 25% to 75% and preferably 45% to 55% of the extracted clarified water circulating in the pipe 18 is re-circulated through the piping 19 in the pre-contact tank 20. The remainder of the clarified water is discharged towards tertiary treatment. This remainder of the clarified water, consisting partly of raw water having undergone a first clarification (coagulation, flocculation, decantation), an adsorption on PAC and a second clarification, forms treated water as understood according to the invention.

The sludges coming from the decanter 17 are extracted therefrom in an underflow through the outlet 172 and then introduced into the hydrocyclone 156 via the piping 24.

The sludges and the microsand are separated in the hydrocyclone 156. A mixture of microsand and a very small quantity of sludges is extracted in an underflow from the hydrocyclone and injected into the flocculation tank 15. A mixture of sludge containing PAC and a very small quantity of microsand is extracted in an overflow from the hydrocyclone 156 and injected via the piping 25 into the thickener tank 26.

Sludges containing PAC get decanted at the bottom of the thickener tank 26. Supernatants are extracted from this thickener tank 26 and re-circulated in the mixing tank 11 through the piping 27. The thickened sludge is extracted from the thickener tank 26 through the outlet 261 and the piping 28. A part of the extracted sludges is removed for subsequent treatment. The other part of the sludges is re-circulated in the pre-contact tank 20 through the piping 29.

6.4. Variants

In one variant, the mixing tank 11 could be replaced by a T-shaped pipe comprising an inlet of water to be treated connected to the piping 10, an inlet of a mixture of treated water and an adsorbent reagent connected to the outlet of the pre-contact tank 20 and an outlet connected to the static mixer 13.

In one variant, the thickener tank 26 as well as the pipings 28 and 29 could also be eliminated. In this case, the sludges coming from the hydrocyclone will be directly extracted from the plant for subsequent treatment without a part of these sludges being re-circulated in the pre-contact tank 20. In such variants, the steps of the process involving these elements will not be implemented. It must be noted that implementing the re-circulation of the sludges makes it possible to save about 10% of the PAC.

It can also be planned to implement liquid/solid separation means other than a lamellar decanter. It could be for example a classic decanter. It is possible for deflector 16 not to be implemented. It is possible that the flocculation tank 15 does not house any flow guide. The static mixer 13 could be replaced by a stirred tank.

In the example described further above, the clarification of water to be treated is a ballasted coagulation-flocculation-decantation process. In another embodiment, it could be a classic coagulation-flocculation-decantation process. It could also be another type of clarification such as for example a coagulation-flocculation-flotation process or the like.

6.5. Trials

A series of seven trials were performed in order to attest to the efficiency of a water treatment technique according to the invention. The results of these trials, which shall be described in greater detail hereinafter, are shown in the table here below:

| | | Trial 1 | Trial 2 | Trial 3 | Trial 4 | Trial 5 | Trial 6 | Trial 7 |
|---|---|---|---|---|---|---|---|---|
| 1st | Coagulant dose (ppm) | 130 | 130 | 130 | 130 | 130 | 70 | 90 |
| Passage | PAC dose (ppm) | 0 | 20 | 40 | 90 | 0 | | |
| 2nd | Coagulant dose (ppm) | | | | | 0 | 70 | 90 |
| Passage | PAC dose (ppm) | | | | | 20 | | |
| | PAC dose re- | | | | | | 20 | 20 |
| | circulation loop | | | | | | | |
| | Average TOC (mg/l) | 2.8 | 2.7 | 2.5 | 2 | 2 | 2.4 | 1.95 |
| | Compliance | No | No | No | Yes | Yes | No | Yes |
| | Investment | 100 | 100 | 100 | 100 | 200 | 165 | 165 |
| | Total coagulant dose | 130 | 130 | 130 | 130 | 130 | 140 | 180 |
| | Total PAC dose | 0 | 20 | 40 | 90 | 20 | 20 | 20 |

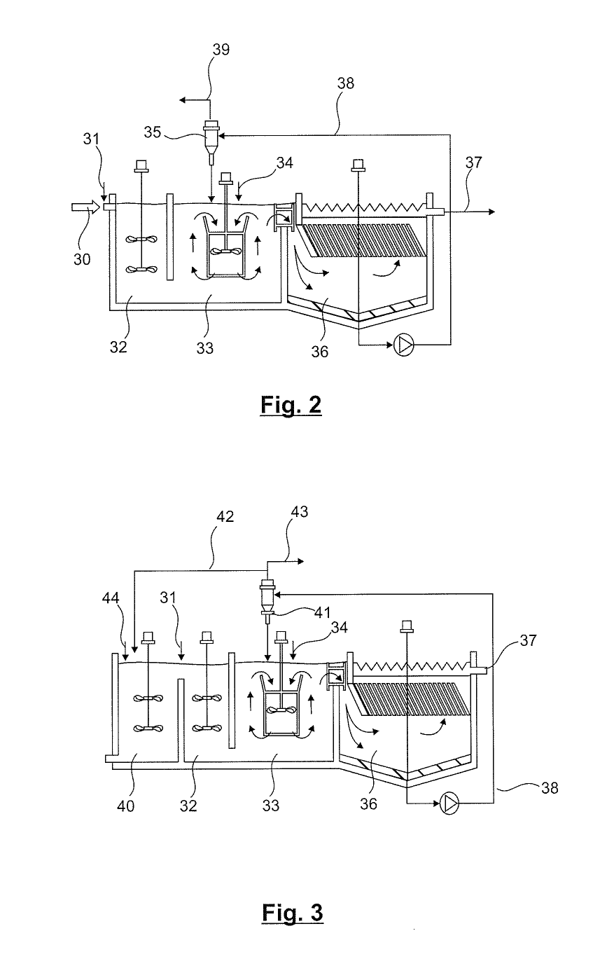

A first trial consisted in making raw water travel through a water treatment plant for water treatment by ballasted coagulation-flocculation-decantation as illustrated in FIG. 2.

Such a plant comprises a piping 30 for conveying raw water into which there lead coagulant injection means 31. The piping 30 leads into a stirred or agitated coagulation tank 32. The stirred coagulation tank 32 communicates with a stirred flocculation tank 33 into which there lead means for injecting flocculent 34 and the underflow of a hydrocyclone 35 from where microsand flows. The flocculation tank 33 opens into a lamellar decanter 36, the overflow of which is connected to a treated water extraction pipe 37 and the underflow of which is connected to a sludge extraction piping 38. The sludge extraction piping 38 leads into the inlet of the hydrocyclone 35, the overflow of which is connected to a sludge discharge piping 39.

The raw water had a DOC concentration of 7.9 to 8.5 mg/l.

The flow rate of treated water was 2 m³/h.

The coagulant was 130 ppm FeCl₃ and the coagulation time was two minutes.

The flocculating polymer was 0.4 ppm AN905.

The microsand was injected into the flocculation tank at 100 l/h such that the microsand concentration therein was equal to 11 g/l.

The sludges were extracted from the decanter and re-circulated in the hydrocyclone at a flow rate of 280 to 300 l/h.

During this first trial, the average concentration in TOC of the treated water was equal to 2.8 mg/l and therefore did not meet the goal of producing water with an average TOC concentration lower than or equal to 2 mg/l.

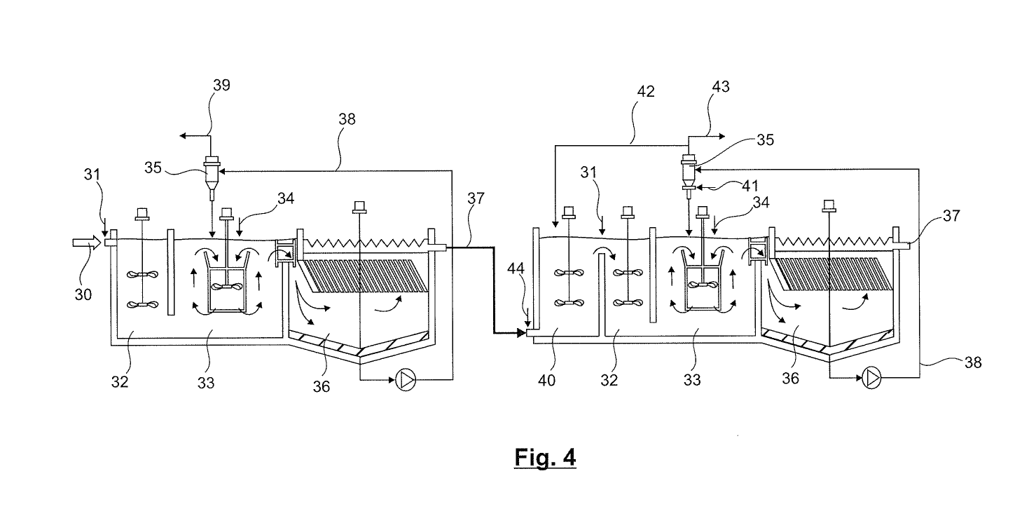

In a second trial, raw water was treated in a plant or installation illustrated in FIG. 3 which is similar to that of FIG. 2 except that it includes a pre-contact tank 40 in which the raw water is put into contact with PAC 44, this pre-contact tank 40 leading into the stirred coagulation tank 32. In this plant, the hydrocyclone 35 has a service water inlet 41. Its overflow is connected to a re-circulation piping 42 for re-circulating PAC in the pre-contact tank 40 and to a piping for extracting used PAC 43. The PAC re-circulation rate ranges from 0% to 50% of the mass flow rate of PAC present in the decanter 36.

During this second trial, 20 ppm of PAC AFP 23 was injected into the pre-contact tank.

The average TOC concentration of treated water during this second trial was equal to 2.7 mg/l and did not achieve the goal of producing water with a average TOC concentration lower than or equal to 2 mg/l.

A third trial consisted in treating raw water in the same way as during the second trial except that 40 ppm of PAC AFP 23 was injected into the raw water.

During this third trial, the average TOC concentration of the treated water was equal to 2.5 mg/l and did not meet the goal of producing water with a average TOC concentration lower than or equal to 2 mg/l.

A fourth trial consisted in treating the raw water in the same way as in the third trial except that 90 ppm of PAC AFP 23 was injected into the raw water.

During this fourth trial, the average TOC concentration of the treated water was equal to 2 mg/l. The implementation of this technique therefore makes it possible to produce treated water complying with requirements. However, it implies high PAC consumption.

In a fifth trial, the inventors series-mounted the plant implemented in the first trial with the plant implemented in the second trial to obtain the plant illustrated in FIG. 4. In this case, the totality of the treated water coming from the overflow of the first decanter was introduced into the pre-contact tank 39.

The flow rate of extracted treated water was 2 m³/h. The doses of coagulant injected into the first and second coagulation tanks were respectively 130 ppm and 0 ppm.

During this fifth trial, the average TOC concentration of the treated water was equal to 2 mg/l. The treated water produced therefore complied with requirements.

The implementation of such a technique therefore enables the production of water compliant with requirements in the same way as the technique implemented during the fourth trial, in entailing however a smaller PAC consumption. However, the investment costs for the plant used in the fifth trial are twice the investment costs for the plant used in the fourth trial.

A sixth trial consisted in making raw water travel in transit through an plant of the kind illustrated in FIG. 1.

The raw water had a DOC concentration of 7.5 to 8.5 mg/l. The flow rate of extracted treated water was 1 m³/h. The flow rate of re-circulated treated water in the pre-contact tank was equal to 1 m³/h.

The coagulant was 70 ppm FeCl₃ and the coagulation time was equal to two minutes.

The polymer was 0.4 ppm AN905.

The PAC was 20 ppm AFP 23 and the contact time of the treated water with the PAC was 50 minutes.

The microsand was injected into the flotation tank at a rate of 100 l/h so that the concentration of microsand therein was equal to 11g/l.

The sludges were extracted from the decanter and re-circulated into the hydrocyclone at a rate of 280 to 300 l/h.

The sludges were extracted from the hydrocyclone at a rate of 200 l/h and then introduced into the thickener tank.

The mixture of treated water and PAC was extracted from the pre-contact tank at a rate of 1 m³/h and injected into the raw water.

During this sixth trial, the average TOC concentration of the treated water was equal to 2.4 mg/l and did not meet the goal of producing water with a average TOC concentration lower than or equal to 2 mg/l.

A seventh trial consisted in processing the raw water in the same way as during the sixth trial except that 90 ppm of coagulant was injected into the raw water.

During this seventh trial, the average TOC concentration of the treated water was equal to 2 mg/l. The treated water produced was therefore compliant with requirements.

Implementing the technique according to the invention therefore enables the production of an identical volume of treated water compliant with requirements, i.e. water with a TOC concentration lower than or equal to 2 mg/l in a plant that is costlier than the plant of the fourth trial but entails PAC consumption about 78% smaller. It also enables the production of an identical volume of treated water compliant with requirements in a plant that is less costly than that implemented in the fifth trial while at the same time entailing an identical consumption of PAC. Indeed, a plant according to the invention has a footprint that is hardly bigger than that of the plant implemented in the fourth trial, and appreciably smaller than that implemented during the fifth trial.

It must be noted that, in the field of drinkable water production, regional and local authorities prefer to acquire plants that cost less to purchase but are slightly costlier to exploit so as not to excessively cut into their investment budget. This is especially true as the duration of the contracts for operating water treatment plants is tending to get reduced, and has gone down from 15 years some years ago to seven years at present.

The implementation of the technique according to the invention makes it possible to obtain a water treatment technique that meets this expectation.

Ultimately, the technique of the invention enables the production, without excess quality, of treated water with a TOC concentration smaller than or equal to 2 mg/l in a relatively compact plant, involving reduced consumption of adsorbent reagent.

6.6. Renovation

A prior art water treatment plant can easily be renovated so as to obtain an plant according to the invention.

Thus, the plant illustrated in FIG. 3 could for example be renovated by: turning the pre-contact tank 40 into a mixing tank;
placing, upstream to this mixing tank, a pre-contact tank that leads into the piping for delivering raw water to the mixing tank;
positioning PAC injection means in the pre-contact tank; and
installing a piping for re-circulating a part of the treated water extracted from the decanter in the pre-contact tank.

The implementing of the technique according to the invention can therefore be part of a policy of sustainable development because it enables the re-utilization, through their modification, of existing water treatment plants which would have been discarded, with the aim of producing treated water with a TOC concentration smaller than or equal to 2 mg/l.

1. Process for treating water to be treated comprising:
a step for clarifying said water to be treated producing a clarified water;
a step for placing a part of said clarified water in contact with a powdered adsorbent reagent producing a mixture of clarified water and powdered adsorbent reagent;
a step for mixing said mixture with said water to be treated;
a step for discharging the remainder of the clarified water.

2. Process according to claim 1, characterized in that said step for clarifying comprises:
a step for coagulating said water to be treated producing coagulated water;
a step for flocculating said coagulated water producing flocculated water;
a step for decanting said flocculated water producing said clarified water and sludges.

3. Process according to claim 1 or 2 characterized in that between 25% and 75% of said clarified water coming from said clarification step or said decantation step is put into contact with said powdered adsorbent reagent.

4. Process according to claim 3, characterized in that between 45% and 55% of said clarified water coming from said clarification step or said decantation step is put into contact with said powdered adsorbent reagent

5. Process according to any one of the claims 1 to 4, characterized in that the dissolved organic carbon concentration of said water to be treated is below 10 mg/l.

6. Process according to any one of the claims 1 to 5, characterized in that said powdered adsorbent reagent is powdered activated carbon.

7. Process according to any one of the claims 2 to 6, characterized in that it comprises a step for thickening said sludges, and a step for introducing the thickened sludges thus obtained into said mixture.

8. Water treatment plant for treating water to be treated to implement a process according to any one of the claims 1 to 7, said plant comprising means for clarifying said water to be treated (13, 14, 15, 154, 17) and means for extracting clarified water at exit from said means for clarifying (13, 14, 15, 154, 17), characterized in that it comprises means (19) for re-circulating a part of said clarified water into a stirred pre-contact zone (20), means for injecting a powdered adsorbent reagent (21) into said pre-contact zone (20), and a mixing zone (10, 11), said mixing zone (10, 11) comprising a first inlet (110) connected to the outlet of said pre-contact zone (20), a second inlet (110) for said water to be treated and an outlet leading into said means for clarifying (111).

9. Water treatment plant according to claim 8, characterized in that said means for clarifying comprise a coagulation zone (13), a flocculation zone (15), and a decantation zone (17) mounted in series, and means (171, 18) for extracting said clarified water at exit from said decantation zone (17), the outlet of said mixing zone (111) leading into said coagulation zone (13).

10. Process for renovating an existing plant for treating water to be treated comprising means (13, 14, 15, 154, 17) for clarifying said water to be treated, characterized in that it comprises:
a step consisting in linking said means (19) for re-circulating a part of the clarified water to the outlet of said clarifying means;
a step consisting in connecting said means (19) for re-circulating to a pre-contact zone (20) comprising means for injecting a powdered adsorbent reagent;
a step consisting in installing a mixing zone (11), of which a first inlet is connected to the outlet of said pre-contact zone, a second inlet is connected to an intake of said water to be treated and the outlet is connected to said means (13, 14, 15, 154, 17) for clarifying.

11. Process for renovating according to claim 10, characterized in that said means for clarifying comprise a coagulation zone (13), a flocculation zone (15 ) and a decantation zone (17) mounted in series, and means (18) for extracting clarified water at exit from said decantation zone (17), said process comprising:
a step consisting in connecting means (19) for re-circulating a part of clarified water to the outlet of said decantation zone (17);
a step consisting in connecting said means (19) for re-circulating to a pre-contact zone (20) comprising means for injecting powdered adsorbent reagent (21);
a step for installing a mixing zone (11), a first inlet of which is connected to the outlet of said pre-contact zone (20), a second inlet of which is connected to an intake of said water to be treated and the outlet of which is connected to said coagulation zone (13)
